(19) United States
(12) Patent Application Publication
(10) Pub. No.: US 2008/0284700 A1
(43) Pub. Date: Nov. 20, 2008

(54) Liquid crystal display device

(76) Inventors: Ryutaro Oke, Chiba (JP); Ikuko Mori, Chiba (JP)

Correspondence Address: REED SMITH LLP, Suite 1400, 3110 Fairview Park Drive, Falls Church, VA, 22042, US

(21) Appl. No.: 12/000,979

(22) Filed: Dec. 19, 2007

(30) Foreign Application Priority Data
Dec. 21, 2006 (JP) 2006-343800
Nov. 9, 2007 (JP) 2007-291713

(51) Int. Cl. G09G 3/36

(52) U.S. Cl. 345/89; 345/87

(57) ABSTRACT

To suppress degradation of image quality caused by using an AC drive method so as to display a high-quality image. If a drive state of each of subpixels at a time when a gray-scale voltage higher than a counter voltage applied to a counter electrode is applied to a pixel electrode is defined as a positive drive state and if the drive state of each subpixel at a time when a gray-scale voltage lower than a counter voltage applied to the counter electrode is applied to the pixel electrode is defined as a negative drive state, an image line drive circuit changes the drive state of each subpixel from the positive drive state to the negative drive state or from the negative drive state to the positive drive state every two frames, as well as inverts a phase of the drive state of each subpixel every N (N≧4) frames. If a gray-scale voltage to be provided to each of image lines by an image line drive circuit in a frame A that is a first frame immediately after the phase inversion is defined as VA, and if a normal gray-scale voltage to be provided to each of the image lines by the image line drive circuit in a frame B that is a normal frame is defined as VB, |VA|<|VB| is satisfied at least with respect to a halftone.

### CLAIM OF PRIORITY

The present application claims priority from Japanese Application JP 2006-343800 filed on Dec. 21, 2006, and Japanese Application JP 2007-291713 filed on Nov. 9, 2007, the content of which is hereby incorporated by references into this application.

### FIELD OF THE INVENTION

The present invention relates to a liquid crystal display device, particularly to a liquid crystal display device that suppresses degradation of image quality caused by using an AC drive method so as to display high-quality images.

### DESCRIPTION OF THE RELATED ART

Thin film transistor (TFT) liquid crystal display modules using thin film transistors as active elements are able to display high-definition images. For this reason, such TFT liquid crystal display modules are used as display device for television sets, personal computers, and the like.

A liquid crystal display module typically includes a so-called “liquid crystal display panel” in which liquid crystal is interposed between two (a pair of) substrates, at least one of which is made of glass or the like. In such a liquid crystal display panel, a thin film transistor that is turned on according to a scan signal from a scan line, and a pixel electrode to which a video signal from a image line is provided via the thin film transistor are formed in each region surrounded by two adjacent scan lines (also called “gate lines”) and two adjacent image lines (also called “source lines” or “drain lines”) so as to form a so-called “subpixel.”

Each image line is coupled to a drain driver disposed near one edge (long edge) of the liquid crystal display panel, and each scan line is coupled to a gate driver disposed near another edge (short edge) thereof. The prior arts describing the above technology are as follows:

(1) Japanese Patent Laid-open No. 2003-99017,

(2) US2003/0058211A1 (US counterpart of Japanese Patent Laid-open No. 2003-99017)

(3) Japanese Patent Laid-open No. 2005-309274,

(4) US2005/0237287A1 (US counterpart of Japanese Patent Laid-open No. 2005-309274)

In order to prevent application of a direct current to the liquid crystal capacity, the liquid crystal is AC-driven in a manner that gray-scale voltages provided to the image lines each change between a gray-scale voltage (hereafter referred to as a “positive (+) gray-scale voltage”) higher than a common voltage (VCOM) applied to the counter electrode and a gray-scale voltage (hereafter referred to as a “negative (−) gray-scale voltage) lower than the common voltage (VCOM) for each horizontal scan period so as to change the polarity. The common symmetrical method is known as such an AC drive method.

FIG. 8 is a schematic diagram simply showing the polarity and voltage of a subpixel in a case where white and black are alternately displayed for each vertical scan period (hereafter referred to as a “frame”) in a related-art liquid crystal display module.

If the gray-scale voltage is changed in accordance with the AC drive cycles of the liquid crystal in a manner that black is displayed when the polarity is negative and white is displayed when the polarity is negative, as shown in FIG. 8, the voltage of the subpixel draws a pattern in which the voltage is disproportionately shifted into the positive polarity (plus) side from the common voltage (VCOM). Accordingly, a direction current is applied to the liquid crystal as an effective value.

In particular, such a pattern frequently occurs when a moving image is displayed, so that a direct current is always applied to the liquid crystal. This degrades the display quality, as well as significantly reduces the life of the liquid crystal.

Also, display data that alternately switches between a white image and a black image for each frame often occurs when an interlaced scan signal such as a television signal is converted into a progressive scan signal to be used to drive the liquid crystal. For example, if a television image or a digital versatile disc (DVD) image is displayed on the liquid crystal display module, the drive voltage of the liquid crystal is disproportionally shifted, which could degrade image quality.

### SUMMARY OF THE INVENTION

An advantage of the present invention is to provide a technology that suppresses image degradation caused by using an AC drive method in a liquid crystal display device so as to display high-quality images.

The above-mentioned and other advantages and novel features of the invention will be apparent from the description of this specification and the accompanying drawings.

A typical aspect of the invention disclosed in this application will be outlined below.

(1) A liquid crystal display device includes: a liquid crystal display panel having plural subpixels and plural image lines that input gray-scale voltages to the subpixels; and an image line drive circuit that provides the gray-scale voltages to the image lines. Each of the subpixels has a pixel electrode and a counter electrode. If a drive state of each of the subpixels at a time when a gray-scale voltage higher than a counter voltage applied to the counter electrode is applied to the pixel electrode is defined as a positive drive state and if the drive state of each subpixel at a time when a gray-scale voltage lower than a counter voltage applied to the counter electrode is applied to the pixel electrode is defined as a negative drive state, the image line drive circuit changes the drive state of each subpixel from the positive drive state to the negative drive state or from the negative drive state to the positive drive state every two frames, as well as inverts a phase of the drive state of each subpixel every N (N≧4) frames. If a gray-scale voltage to be provided to each of the image lines by the image line drive circuit in a frame A that is a first frame immediately after the phase inversion is defined as VA, and a normal gray-scale voltage to be provided to each of the image lines by the image line drive circuit in a frame B that is a normal frame is defined as VB, |VA|<|VB| is satisfied at least with respect to a halftone.

(2) (1) further includes a gray-scale reference voltage generation circuit that generates plural gray-scale reference voltages. The image line drive circuit preferably includes a gray-scale voltage generation circuit that generates the gray-scale voltages based on plural gray-scale reference voltages inputted from the gray-scale reference voltage generation circuit. If the gray-scale reference voltages generated by the gray-scale reference voltage generation circuit in the frame A are defined as a first group of gray-scale reference voltages, if the gray-scale reference voltages forming the first group are defined as VR1 to VRj (j≧3), if the gray-scale reference voltages generated by the gray-scale reference voltage generation circuit in the frame B are defined as a second group of gray-scale reference voltages, and if the gray-scale reference voltages forming the second group are defined as V1 to Vj, |VRk|<|Vk|(k=2 to (j−1)) is preferably satisfied.

(3) In (2), the display panel preferably includes plural scan lines that input selection scan voltages to the subpixels. The gray-scale reference voltage generation circuit preferably changes the gray-scale reference voltages VRk (k=2 to (j−1)) according to positions of the scan lines to which the selection scan voltages are to be provided. The image line drive circuit preferably changes a value of the |VA| at least with respect to a halftone according to distances from the image line drive circuit to the scan lines when the gray-scale voltages are written to the subpixels on the scan lines to which the selection scan voltages are to be provided.

(4) In (3), if the VA in a case in which the scan lines to which the selection scan voltages are to be provided are located in a position near the image line drive circuit is defined as VAn, if the VA in a case in which the scan lines to which the selection scan voltages are to be provided are located in a position far from the image line drive circuit is defined as VAf, and if the VA in a case in which the scan lines to which the selection scan voltages are to be provided are located in a middle position between the position near the image line drive circuit and the position far from the image line drive circuit is defined as VAm, |VAn|<|VAm|<|VAf| is preferably satisfied at least with respect to a halftone.

(5) Anyone of (1) to (4) includes a temperature detector that detects a temperature of the liquid crystal display panel. The VA is preferably set up according to a temperature detected by the temperature detector.

(6) In (5), if a first temperature is defined as T1, if a second temperature that is higher than the first temperature is defined as T2, if a value of the VA at a time when a temperature detected by the temperature detector is the T1 is defined as VAT1, and if a value of the VA at a time when a temperature detected by the temperature detector is the T2 is defined as VAT2, |VAT1|>|VAT2| is preferably satisfied at least with respect to a halftone.

(7) In (6), if the first group of gray-scale reference voltages generated by the gray-scale reference voltage generation circuit when a temperature detected by the temperature detector is the T1 are defined as VRT1 to VRjT1 (j≧3), and if the first group of gray-scale reference voltages generated by the gray-scale reference voltage generation circuit when a temperature detected by the temperature detector is the T2 are defined as VR1T2 to VTjT2, |VRkT1|>|VRkT2|(k=2 to (j−1)) is satisfied.

(8) In (6), if a gray-scale voltage provided to each of the image lines by the image line drive circuit in a frame C following the frame A that is the first frame immediately after the phase inversion when a temperature detected by the temperature detector is the T2 is defined as VA2, |VB|<|VA2| is preferably satisfied at least with respect to a halftone.

(9) In (8), if the first group of gray-scale reference voltages generated by the gray-scale reference voltage generation circuit in the frame C are defined as VRC1 to VRCj (j≧3), |Vk|<|VRCk| (k=2 to (j−1)) is satisfied.

(10) Any one of (2), (3), (7), and (9) further includes a display control circuit. The gray-scale reference voltage generation circuit preferably sets up values of the gray-scale reference voltages to be generated in each frame based on gray-scale reference voltage data from the display control circuit.

(11) In (10), the display control circuit preferably includes a memory that stores the gray-scale reference voltage data. The display control circuit preferably reads the gray-scale reference voltage data stored in the memory and transmits the read gray-scale reference voltage data to the gray-scale reference voltage generation circuit.

(12) In (11), the memory is preferably an erasable programmable read-only memory (EEPROM).

(13) A liquid crystal display device includes: a liquid crystal display panel having plural subpixels, plural scan lines that input scan voltages to the subpixels, plural image lines that input image voltages to the subpixels; a scan line drive circuit that provides the scan voltages to the scan lines; and an image line drive circuit that provides the image voltages to the image lines. Each of the subpixels has a pixel electrode and a counter electrode. If a drive state of each of the subpixels at a time when a gray-scale voltage higher than a counter voltage applied to the counter electrode is applied to the pixel electrode is defined as a positive drive state and if the drive state of each subpixel at a time when a gray-scale voltage lower than a counter voltage applied to the counter electrode is applied to the pixel electrode is defined as a negative drive state, the image line drive circuit changes the drive state of each subpixel from the positive drive state to the negative drive state or from the negative drive state to the positive drive state every two frames, as well as inverts a phase of the drive state of each subpixel every N (N≧4) frames. If a length of one horizontal scan period is defined as Ha and if an arbitrary value is defined as α, a length of one horizontal scan period in a frame A that is a first frame immediately after the phase inversion is set to (Ha−α) and a length of one horizontal scan period in a frame B that is a normal frame is set to the Ha.

(14) In (13), the liquid crystal display device further includes a display control circuit that transmits a shift clock to the scan line drive circuit. The display control circuit changes a pulse width of the shift clock so that a length of one horizontal scan period in the frame A becomes (Ha−α) and so that a length of one horizontal scan period in the frame B becomes the Ha.

(15) In (14), a high-level pulse width of the shift clock in one horizontal scan period in the frame A is wider than a high-level pulse width of the shift clock in one horizontal scan period in the frame B.

(16) A liquid crystal display device includes: a liquid crystal display panel having plural subpixels, plural scan lines that input scan voltages to the subpixels, and plural image lines that input image voltages to the subpixels; a scan line drive circuit that provides the scan voltages to the scan lines; and an image line drive circuit that provides the image voltages to the image lines. Each of the subpixels has a pixel electrode and a counter electrode. If a drive state of each of the subpixels at a time when a gray-scale voltage higher than a counter voltage applied to the counter electrode is applied to the pixel electrode is defined as a positive drive state and if the drive state of each subpixel at a time when a gray-scale voltage lower than a counter voltage applied to the counter electrode is applied to the pixel electrode is defined as a negative drive state, the image line drive circuit changes the drive state of each subpixel from the positive drive state to the negative drive state or from the negative drive state to the positive drive state every two frames, as well as inverts a phase of the drive state of each subpixel every N (N≧4) frames. If an image voltage reference write time in one horizontal scan period is defined as Hb and if an arbitrary value is defined as β, an image voltage reference write time in one horizontal scan period in a frame A that is a first frame immediately after the phase inversion is set to (Ha−β) and an image voltage reference write time in one horizontal scan period in a frame B that is a normal frame is set to the Hb.

(17) (16) further includes a display control circuit that transmits an output timing control clock to the image line drive circuit. The display control circuit preferably changes a pulse width of the output timing control clock so that an image voltage reference write time in one horizontal scan period in the frame A becomes (Ha−β) and an image voltage reference write time in one horizontal scan period in the frame B becomes the Hb.

(18) In (17), a high-level pulse width of the output timing control clock in one horizontal scan period in the frame A is wider than a high-level pulse width of the output timing control clock in one horizontal scan period in the frame B.

(19) In any one of (1) to (18), the image line drive circuit changes a drive state of each of the subpixels from the positive drive state to the negative drive state or from the negative drive state to the positive drive state for each frame, as well as inverts a phase of the drive state of each of the subpixels every M (M≧2) frames.

(20) In any one of (1) to (19), the counter voltage applied to the counter electrode is a constant voltage.

(21) In any one of (1) to (20), the liquid crystal display panel preferably includes a pair of substrates between which liquid crystal is interposed. The pixel electrode and the counter electrode are formed on one of the pair of substrates. The pixel electrode and the counter electrode are stacked with an insulating film therebetween.

The effects obtained by typical embodiments of the invention will be briefly described below.

According to the liquid crystal display device according to the present invention, image degradation caused by alternating drive is prevented so as to display high-quality images.

### BRIEF DESCRIPTION OF THE DRAWINGS

Embodiments of the present invention will be described in detail with reference to the accompanying drawings, wherein:

FIG. 1 is a block diagram showing a schematic configuration of a liquid crystal display module according to a first embodiment of the present invention;

FIG. 2 a block diagram showing a schematic circuit configuration of a drain driver shown in FIG. 1;

FIGS. 3A and 3B are diagrams showing a configuration of a gray-scale voltage generation circuit shown in FIG. 2;

FIG. 4 is a diagram showing an example of a gray-scale reference voltage generation circuit shown in FIG. 1;

FIG. 5 is a sectional view showing a schematic structure of the liquid crystal display panel according to the first embodiment;

FIG. 6 is a diagram showing a phase inversion drive method used in the liquid crystal display module according to the first embodiment;

FIG. 7 is a block diagram showing a schematic configuration of a liquid crystal display module according to a second embodiment of the present invention;

FIG. 8 is a schematic diagram simply showing the polarity and voltage level of a subpixel in a case where white and black are alternately displayed for each vertical scan period (hereafter referred to as a “frame”) in a related-art liquid crystal display module;

FIG. 9 is a schematic diagram showing the subpixel polarity for each frame in a case in which the phase of the subpixel polarity is inverted each time a given period (period A, period B) has elapsed if white and black are alternately displayed for each frame as shown in FIG. 8;

FIG. 10 is a schematic diagram simply showing the polarity and voltage level of a subpixel in a case in which white and black are alternately displayed for each frame if the phase inversion drive method is used;

FIG. 11 is a schematic diagram simply showing the polarity and voltage level of a subpixel in a case in which the polarity of the subpixel is changed from positive to negative or from negative to positive every two frames if a white image and a black image is alternately displayed for each frame;

FIG. 12 is a schematic diagram simply showing the polarity and voltage level of a subpixel in a case in which the polarity of the subpixel is changed from positive to negative or from negative to positive every two frames if white and black are alternately displayed for each frame as shown in FIG. 11;

FIG. 13 is a diagram showing an image voltage written to a subpixel in the first frame immediately after a phase inversion and an image voltage written to a subpixel in an normal frame in a liquid crystal module according to a third embodiment of the present invention;

FIG. 14 is a block diagram showing a configuration of circuits for performing the timing control shown in FIG. 13;

FIG. 15 is a diagram showing an image voltage written to a subpixel in the first frame immediately after a phase inversion and an image voltage written to a subpixel in a normal frame in a liquid crystal display module according to a modification of the third embodiment;

FIG. 16 is a block diagram showing a configuration of circuits for performing the timing control shown in FIG. 15; and

FIG. 17 is a diagram showing the reason why flicker occurs in the first frame immediately after a phase inversion if the phase inversion drive method shown in FIG. 12 is used.

### DETAILED DESCRIPTION OF THE PREFERRED EMBODIMENTS

Embodiments of the present invention will now be described in detail with reference to the drawings.

Like reference numerals designate like elements in all the drawings for describing the embodiments and will not be repeatedly described.

### First Embodiment

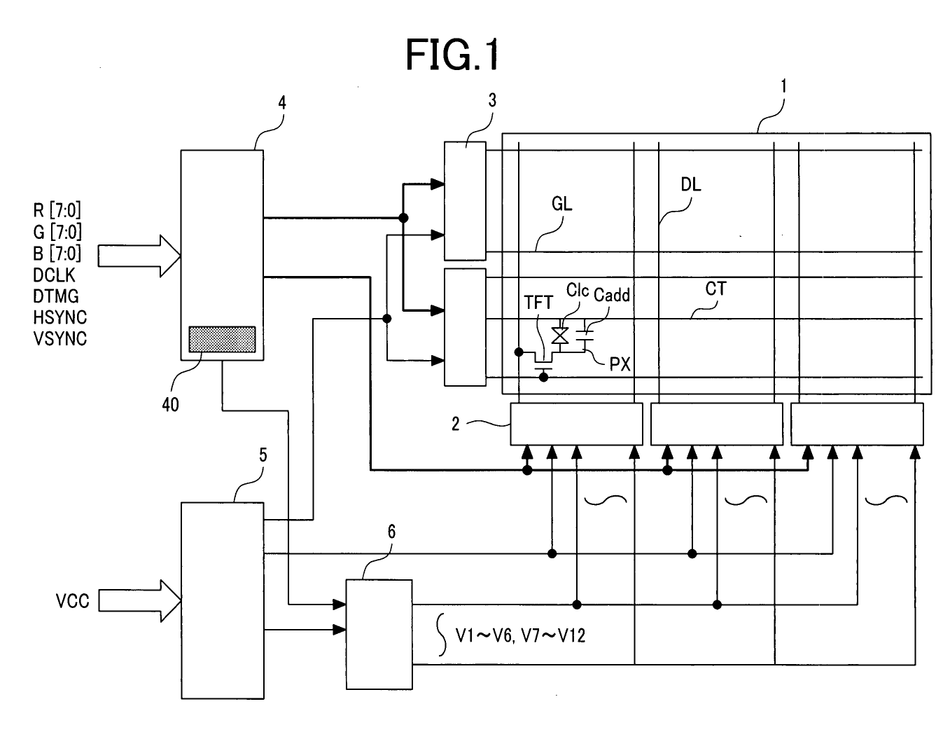

FIG. 1 is a block diagram showing a schematic configuration of a liquid crystal display module according to a first embodiment of the present invention. The liquid crystal display module according to this embodiment includes a liquid crystal display panel 1, a drain driver 2, a gate driver 3, a display control circuit (timing controller) 4, a power supply circuit 5, and a gray-scale reference voltage generation circuit 6.

The drain driver 2 includes semiconductor chips disposed near one edge of the liquid crystal panel 1, and the gate driver 3 includes semiconductor chips disposed near another edge thereof.

A display control circuit 4 includes a memory (e.g., electronically erasable and programmable read-only memory (EEPROM)) 40, and timing-adjusts display data (R [7:0], G [7:0], B [7:0]) inputted from a display signal source (host) such as a television reception circuit, according to a dot clock (DCLK), a display timing signal (DTMG), a horizontal synchronizing signal (HSYNG), and a vertical synchronizing signal (VSYNC), such as by alternating the display data, so that the display data is properly displayed on the liquid crystal display panel 1. Then the display control circuit 4 inputs the timing-adjusted display data into the drain driver 2 and the gate driver 3 together with a synchronizing signal (clock signal).

Under the control of the display control circuit 4, the gate driver 3 provides scan voltages to scan lines GL and the drain driver 2 provides gray-scale voltages to image lines DL so that an image is displayed. The power supply circuit 5 generates various types of voltages required by the liquid crystal display device, and the gray-scale reference voltage generation circuit 6 generates gray-scale reference voltages V1 to V12.

In FIG. 1, TFT represents a thin film transistor, PX represents a pixel electrode, CT represents a counter electrode, Clc represents a liquid crystal capacitance equivalently indicating a liquid crystal layer, and Cadd represents a holding capacitance formed between the pixel electrode PX and the counter electrode CT.

In the liquid crystal display panel 1 shown in FIG. 1, first electrodes (drain electrodes or source electrodes) of thin film transistors TFT in subpixels arranged in the column direction are coupled to the image lines DL, which are coupled to the drain driver 2 for providing gray-scale voltages corresponding to display data, to the subpixels.

Gate electrodes of thin film transistors TFT in subpixels arranged in the row direction are coupled to the scan lines GL, which are coupled to the gate driver 3 for providing scan voltages (positive or negative bias voltages) to the gate electrodes of the thin film transistors TFT for one horizontal scan period.

When an image is displayed on the liquid crystal display panel 1, the gate driver sequentially selects the scan lines GL from top to bottom (or from bottom to top). On the other hand, the drain driver 2 provides gray-scale voltages corresponding to display data, to the image lines DL while a scan line is selected.

The voltages provided to the image lines DL are applied to the pixel electrodes PX via the thin film transistors TFT. Finally, electric charge is carried by the holding capacitances Cadd and the liquid crystal capacitances Clc so as to control liquid crystal particles. Thus, an image is displayed.

Here, it is assumed that the liquid crystal display panel 1 operates in so-called “normally black-displaying mode” in which brightness is increased as the gray-scale voltages to be provided to the subpixels are increased.

The liquid crystal display panel 1 is formed by stacking a first substrate (also called as a “TFT substrate” or an “active matrix substrate”), on which the pixel electrodes PX, the counter electrode CT, the thin film transistors TFT, the image lines DL, the scan lines GL, and the like are formed, and a second substrate (also called a “counter substrate”), on which color filters and the like are formed, with a predetermined gap provided therebetween, bonding together these substrates using a frame-shaped sealing material interposed between the peripheries of these substrates, sealing in liquid crystal from an liquid crystal inlet provided in a part of the sealing material, and attaching polarizing plates to the outer surfaces of these substrates.

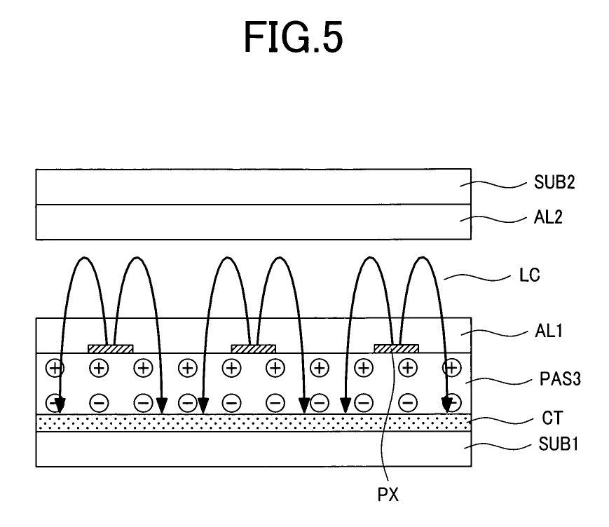

FIG. 5 is a sectional view showing a schematic structure of the liquid crystal display panel 1 according to this embodiment.

As shown in FIG. 5, the comb-teeth-shaped pixel electrodes PX and the planar counter electrode CT are stacked on the first substrate SUB1 with an insulating film PAS3 between these electrodes. Arch-shaped electric lines of force formed between the pixel electrodes PX and the counter electrode CT are distributed in a manner that these electric lines of force pass through a liquid crystal layer LC. This changes the orientation of the liquid crystal in the liquid crystal layer LC, determining the light transmission. In FIG. 5, AL1 and AL2 represent orientation films.

In an actual product, a backlight is disposed on the back of the liquid crystal display panel 1. However, the backlight will not be described in detail, because the present invention is not related to the structure of the backlight.

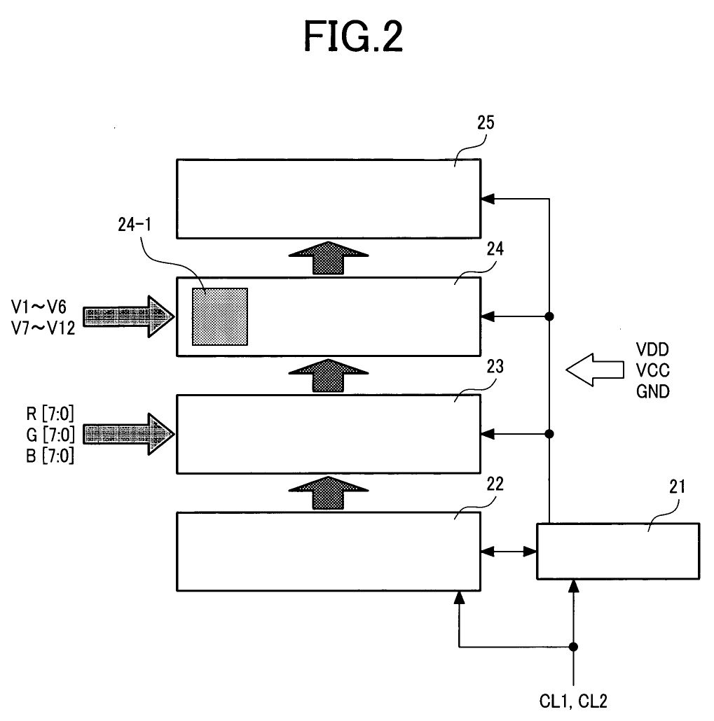

FIG. 2 a block diagram showing a schematic circuit configuration of the drain driver 2 shown in FIG. 1.

In FIG. 2, the drain driver circuit 2 includes a clock control part 21, a latch address selector 22, a latch circuit 23, a D/A converter circuit 24, and an output amplifier circuit 25.

Under the control of the latch address selector 22, the latch circuit 23 sequentially latches display data (R [7:0], G [7:0], B [7:0]) inputted from outside in synchronization with a display data latch clock CL2 outputted from the display control circuit 4.

Display data latched by the latch circuit 23 is outputted to the D/A converter circuit 24 according to an output timing control clock signal CL1 outputted from the display control circuit 4.

The D/A converter circuit 24 includes a gray-scale voltage generation circuit 24-1 that generates positive and negative 0 to 255-level gray-scale voltages according to positive gray-scale reference voltages V1 to V6 and negative gray-scale reference voltages V7 to V12 inputted from the gray-scale reference voltage generation circuit 6.

The D/A converter circuit 24 selects gray-scale voltages corresponding to the display data inputted from the latch circuit 23, from among the positive and negative 0 to 255-level gray-scale voltages generated by the gray-scale voltage generation circuit 24-1, and then outputs the selected voltages to the output amplifier circuit 25.

The output amplifier circuit 25 current-amplifies the gray-scale voltages inputted from the D/A converter circuit 24 using an amplifier circuit, and then outputs the current-amplified gray-scale voltages to the corresponding image lines DL.

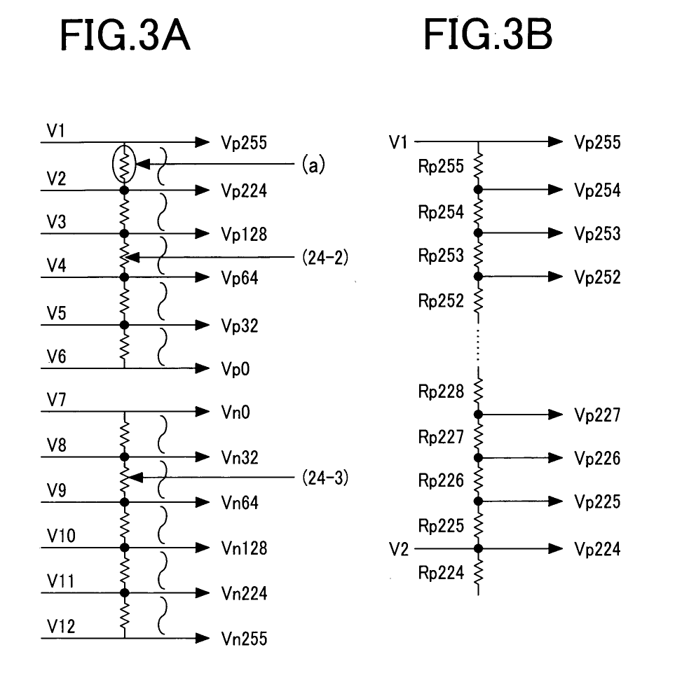

FIGS. 3A and 3B are diagrams showing circuit configurations of the gray-scale voltage generation circuit 24-1 shown in FIG. 2. FIG. 3A is a diagram showing an overall circuit configuration of the gray-scale voltage generation circuit 24-1, and FIG. 3B is an enlarged diagram showing a part indicated by the (a) of FIG. 3A.

As shown in FIG. 3A, the gray-scale voltage generation circuit 24-1 includes a part that divides the differences among six gray-scale reference voltages V1 to V6 inputted from the gray-scale reference voltage generation circuit 6 using a series resistance voltage divider circuit 24-2 so as to generate positive 0 to 255-level gray-scale voltages, and a part that divides the differences among six gray-scale reference voltages V7 to V12 inputted from the gray-scale reference voltage generation circuit 6 using a series resistance voltage divider circuit 24-3 so as to generate negative 0 to 255-level gray-scale voltages.

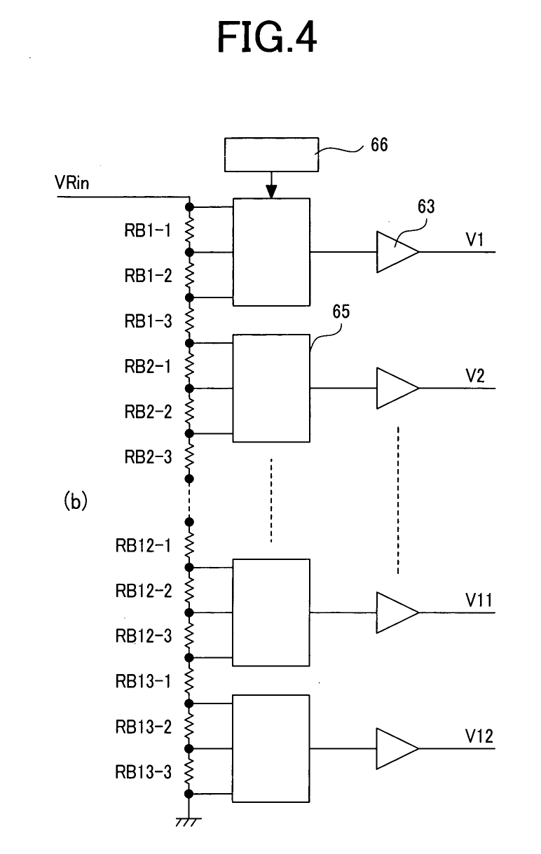

FIG. 4 is a diagram showing an example of the gray-scale reference voltage generation circuit 6 shown in FIG. 1. The gray-scale reference voltage generation circuit 6 shown in FIG. 4 includes resistance voltage divider circuits. The gray-scale reference voltages V1 to V12 are set up according to the ratio among the resistance values of the voltage divider resistances. Outputs of the resistance voltage divider circuits are current-amplified by buffer circuits 63 and then outputted to the gray-scale voltage generation circuit 24-1 of the drain driver 2.

In FIG. 4, the voltage divider resistance includes three resistances (RB1-1, RB1-2, RB1-3), (RB2-1, RB2-2, RB2-3) to (RB12-1, RB12-2, RB12-3), and (RB13-1, RB13-2, RB13-3), one of which is selected by the selector circuit 65.

The gray-scale reference voltage generation circuit 6 also includes a register 66 and controls the selector circuit 65 according to control data outputted from the register 66. In this case, the gray-scale reference voltage generation circuit 6 previously obtains data on a first group of gray-scale reference voltage and data on a second group of gray-scale reference 66 from the display control circuit 4 to store the obtained data in the register 66. Then, by changing the control data to be outputted from the register 66 according to an instruction from the display control circuit 4 to change the resistance to be selected by the selector circuit 65, the gray-scale reference voltage generation circuit 6 outputs the first group of gray-scale reference voltage data or the second group of gray-scale reference data to the gray-scale voltage generation circuit 24-1 of the drain driver 2. The data on the first group of gray-scale reference voltage data and the data on the second group of gray-scale reference data is stored in the memory 40 of the display control circuit 4 as gray-scale reference voltage data.

### [Phase Inversion Drive Method]

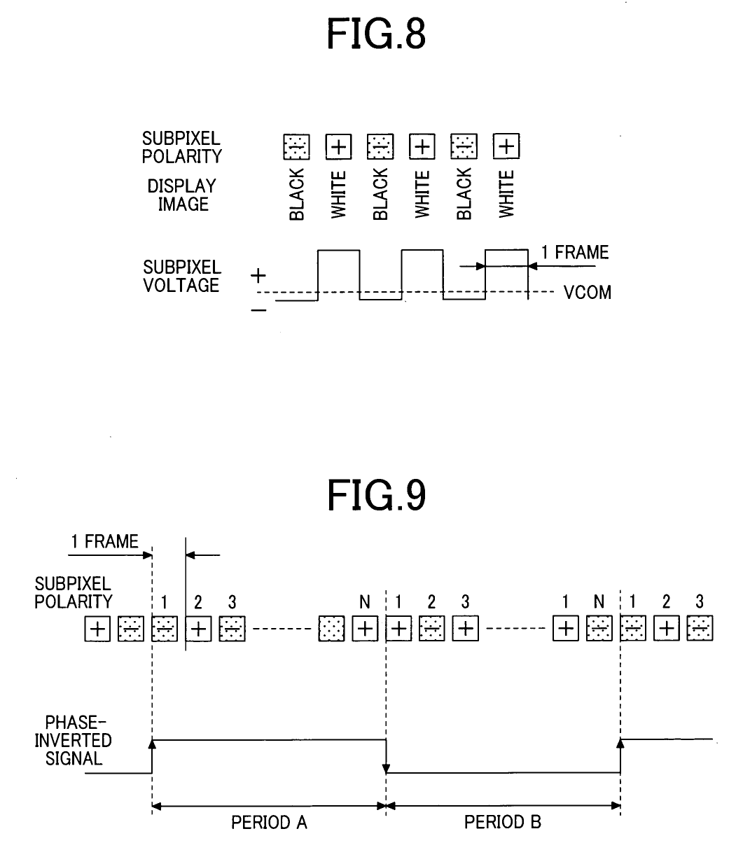

FIG. 9 is a schematic diagram showing the polarity of a subpixel in each frame in a case in which the phase of the subpixel polarity is inverted each time a given period (period A, period B) has elapsed if white and black are alternately displayed for each frame as shown in FIG. 8.

If the phase of the subpixel polarity is inverted using a phase-inverted signal shown in FIG. 9, for example, the period A starts with a negative (−) drive state and the period B starts with a positive (+) drive state. Therefore, if a comparison is made between the subpixel polarity in each frame of the period A and that in each corresponding frame of the period B, it is understood that the subpixel polarity is entirely opposite between the period A and the period B. Hereafter, this AC drive method will be referred to as a “phase inversion drive method” (see Japanese Unexamined Patent Application Publication No. 2005-309274 (related U.S. Publication No. 2005/0237287A1)).

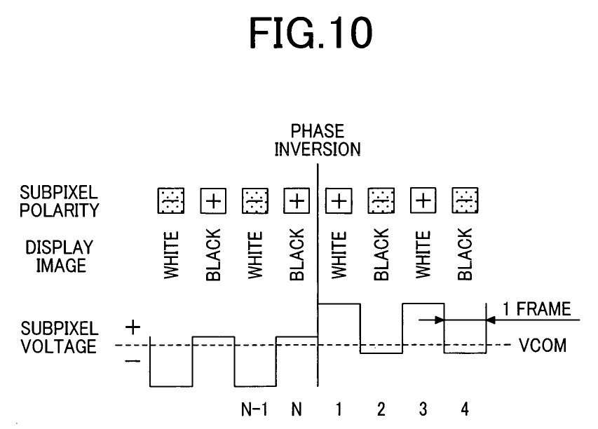

FIG. 10 is a schematic diagram simply showing the polarity and voltage level of a subpixel in a case in which this phase inversion drive method is used.

As shown in FIG. 10, by using the phase inversion drive method, the voltage of the subpixel, which has been disproportionately shifted into the negative polarity side (minus side) from the common potential (VCOM), is disproportionately shifted into the positive polarity side (plus side) after a phase inversion.

As described above, the liquid crystal is AC-driven so that the voltage of the subpixel is disproportionately shifted into the positive polarity side or negative polarity side each time a given period has elapsed. As a result, an effective direct current to be applied to the liquid crystal is reduced.

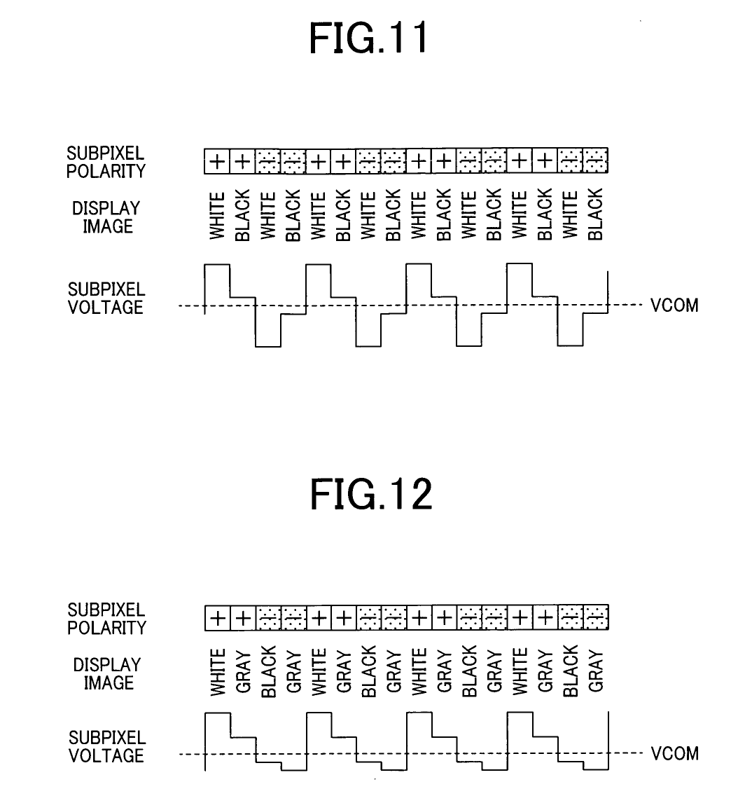

The problem that, when the AC drive method shown in FIG. 8 is used, the voltage of the subpixel is disproportionally shifted into the positive polarity side (plus side) or negative polarity side (minus side) from the common potential (VCOM) and therefore a direct current is applied to the liquid crystal as an effective value is also solved by using a drive method shown in FIG. 11.

FIG. 11 is a schematic diagram simply showing the polarity and voltage level of a subpixel in a case in which the polarity of the subpixel is changed from positive to negative or from negative to positive every two frames if white and black are alternately displayed for each frame.

While the polarity of a subpixel is changed from positive to negative or from negative to positive for each frame in the AC drive method shown in FIG. 8, the polarity of a subpixel is changed from positive to negative or from negative to positive every two frames in a drive method shown in FIG. 11.

Therefore, as shown in FIG. 11, the voltage of the subpixel is not disproportionately shifted into the positive polarity side (plus side) or negative polarity side (minus side) from the common voltage (VCOM). As a result, an effective direct voltage to be applied to the liquid crystal is reduced.

In recent years, liquid crystal display devices are required to speed up the rate of one frame from 60 Hz to 120 Hz. If the rate of one frame is speed up to 120 Hz, an image between images in two adjacent frames each having a frequency of 60 Hz is typically generated by interpolating respective data on the images in the two adjacent frames each having a frequency of 60 Hz.

If white and black are alternately displayed in a subpixel for each frame having a rate of 60 Hz, as shown in FIG. 8, the image displayed in a subpixel for each frame including an image generated by interpolation and having a rate of 120 Hz changes from white to gray, black, gray, white, gray, black, and gray, as shown in FIG. 12. In other words, if images in two adjacent frames each having a frequency of 60 Hz are a white image and a black image, an image in a frame having a rate of 120 Hz generated by interpolation is made a gray image.

Therefore, as shown in FIG. 12, if the gray-scale voltage is changed in accordance with AC drive cycles of the liquid crystal in which positive “white” and positive “gray”, and negative “black” and negative “gray” are alternately displayed every two frames, the voltage of the subpixel is disproportionally shifted from the common voltage (VCOM) into the positive polarity side (plus side). As a result, a direct current is applied to the liquid crystal as an effective value. [Phase Inversion Drive Method according to Present Invention]

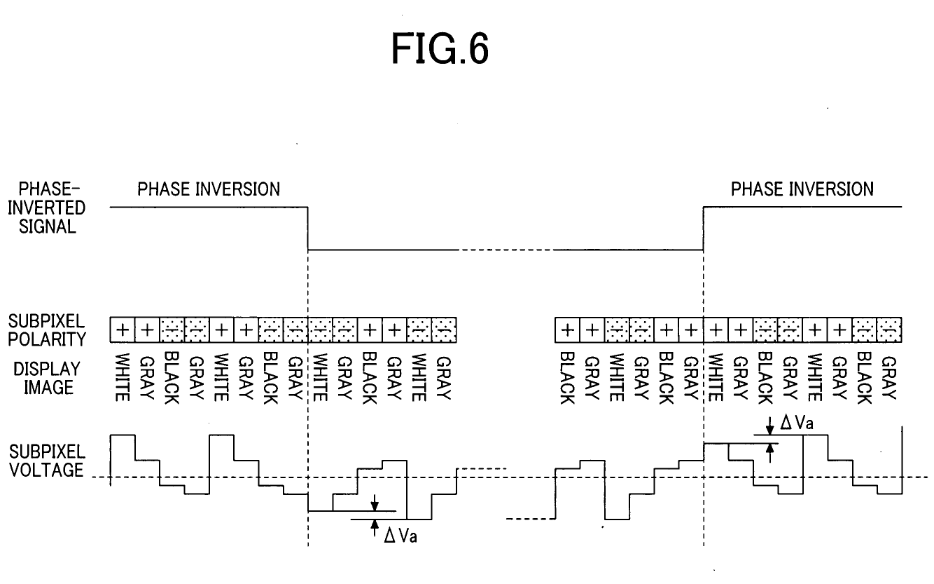

FIG. 6 is a diagram showing a phase inversion drive method performed on the liquid crystal display module according to this embodiment.

In the case of this embodiment, the phase of a subpixel is inverted each time a given period has elapsed (corresponding to the period A or the period B shown in FIG. 9) if the drive method shown in FIG. 12 is used. According to this phase inversion drive method, as shown in FIG. 6, the voltage of the subpixel, which has disproportionally shifted from the common potential (VCOM) into the negative polarity side (minus side), is shifted into the positive polarity side (plus side) after a phase inversion.

Thus, the liquid crystal is AC-driven so that the disproportional shift of the voltage of the subpixel into one polarity side (positive polarity side or negative polarity side) is changed to that into the opposite polarity side each time a given period has elapsed. This reduces an effective direct voltage to be applied to the liquid crystal.

In this case, the subpixel has continuous identical (positive or negative) polarities in the first two frames immediately after a phase inversion, as shown in FIG. 6. Depending on the timing when the phase is inverted, the subpixel may have continuous identical polarities such as (−) (−)→(−) (−) or (+) (+)→(+) (+).

If the subpixel has such continuous identical polarities, the condition for driving (AC-driving) the liquid crystal is seemingly changed. As a result, flicker (phenomenon in which brightness is increased) occurs on the display screen as a side effect.

Such flicker occurs at the timing when the phase-inverted signal shown in FIG. 6 is inverted. Specifically, flicker occurs in the first frame immediately after the rising edge or falling edge of the phase-inverted signal. As a result, the phase inversion drive method has an advantage in that application of a direct current voltage to the liquid Crystal is prevented, while it presents a problem of causing flicker as a side effect that results in degradation of display quality. Note that such flicker also occurs in a case where the phase of the subpixel is inverted each time a given period (period A, period B) has elapsed if white and black are alternately displayed for each frame as shown in FIG. 10.

In this embodiment, as shown in FIG. 6, if the subpixel has continuous identical polarities such as (−) (−)→(−) (−) or (+) (+)→(+) (+) by using the phase inversion drive method, the voltage of the subpixel is made lower than usual by a voltage (hereafter referred to as a “correction voltage”) indicated by ΔVa of FIG. 6 in the first frame immediately after a phase inversion. Thus, as described above, flicker (an increase in brightness) is prevented.

A method will now be described for making lower the voltage of the subpixel in the first frame immediately after a phase inversion (hereafter referred to as a “frame A”) than that in a normal frame (hereafter referred to as a “frame B”) in this embodiment.

The gray-scale reference voltage generation circuit 6 outputs a first group of gray-scale reference voltages to the gray-scale voltage generation circuit 24-1 in the frame A and a second group of gray-scale reference voltages thereto in the frame B.

The gray-scale voltage generation circuit 24-1 shown in FIG. 2 divides the differences among the twelve gray-scale reference voltages V1 to V12 inputted from the gray-scale reference voltage generation circuit 6, using series resistance voltage divider circuits 24-2 and 24-3 so as to generate positive and negative 0 to 255-level gray-scale voltages.

More specifically, the gray-scale voltage generation circuit 24-1 generates the first group of positive and negative 0 to 255-level gray-scale voltages in the frame A and the second group of positive and negative 0 to 255-level gray-scale voltages in the frame B.

Here, if the gray-scale reference voltages forming the first group generated in the frame A are defined as VR1 to VR12 (j≧3), and the gray-scale reference voltages forming the second group generated in the frame B are defined as V1 to V12, the VR1 to VR12 and the V1 to V12 satisfy First Formula below.

|VR1|=|V1|

|VR12|=|V12|

|VRk|<|Vk|(k=2 to 11) [First Formula]

Therefore, in this embodiment, the absolute values of the positive and negative 0 to 255-level gray-scale voltages forming the first group to be provided to the image lines DL in the frame A are made smaller in at least halftones than those of the positive and negative 0 to 255-level gray-scale voltages forming the second group to be provided to the image lines DL in the frame B (|VA|<|VB|). This prevents the above-mentioned flicker (an increase in brightness).

In general, the relation between the voltage applied to the liquid crystal layer and the transmittance of the liquid crystal layer is not linear. An area of the liquid crystal layer having high transmittance corresponding to the maximum gray level and an area thereof having low transmittance corresponding to the minimum gray level each make a small change in transmittance with respect to the voltage applied to the liquid crystal layer. On the other hand, areas of the liquid crystal layer having medium transmittance corresponding to halftones make large changes in transmittance with respect to the voltage applied to the liquid crystal layer. For this reason, in this embodiment, |VA|<|VB| is satisfied at least with respect to halftones except for gray levels around the minimum one and gray levels around the maximum one.

The optimal value of the correction voltage indicated by ΔVa of FIG. 6 varies with each gray level. Therefore, the first group of gray-scale reference voltages VR1 to VR12 are set up so that the correction voltage indicated by ΔVa of FIG. 6 becomes the optimal value for each gray level.

The optimal value of the correction voltage shown in FIG. 6 differs among an area of the liquid crystal display panel 1 near the drain driver 2 (hereafter referred to as an “upper part of the liquid crystal display panel 1”), an area thereof distant from the drain driver 2 (hereafter referred to as a “lower part of the liquid crystal display panel 1”), and an area thereof between these areas (hereafter referred to as a “central part of the liquid crystal display panel 1”).

Specifically, if the optimal value of the correction voltage for the upper part of the liquid crystal display panel 1 is defined as VAn, that for the central part of the liquid crystal display panel 1 as VAm, and that for the lower part of the liquid crystal display panel 1 as VAf, the VAn, VAm, and VAf have the relation represented by Second Formula below.

|VAn|<|VAm|<|VAf| [Second Formula]

In this case, in this embodiment, the upper part, the central part, and the lower part of the liquid crystal display panel 1 may be detected by counting the number of display lines to which to write gray-scale voltages (scan lines DL to which to provide selected scan voltages), and then the above-mentioned first group of gray-scale reference voltages VR1 to VRj may be changed so that the VR1 to VRj are matched with the detected respective areas.

Specifically, the first group of gray-scale reference voltages VR1 to VR12 may be selected from among the three types of the first group of gray-scale reference voltages and outputted to the gray-scale voltage generation circuit 24-1 of the drain driver 2 in one frame by previously storing, in the register 66, data on three types of the first group of gray-scale reference voltages corresponding to the upper part, the central part, and the lower part of the liquid crystal display panel 1, and then by changing control data to be outputted from the register 66 according to an instruction from the display control circuit 4, according to the scan position of the liquid crystal display panel 1 (the position of a scan line DL to which a selected scan voltage is to be provided) so as to change the resistance to be selected by the selector circuit 65. The data on the three types of first group of gray-scale reference voltages is stored in the memory 40 of the display control circuit 4 as data on the gray-scale reference voltage.

### Second Embodiment

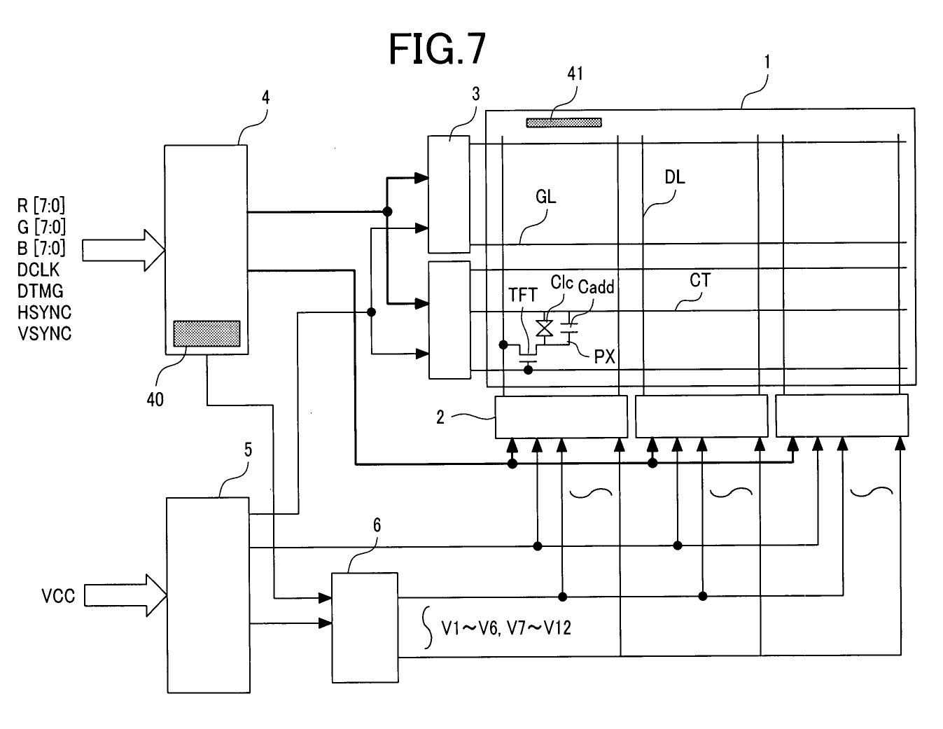

FIG. 7 is a block diagram showing a schematic configuration of a liquid crystal display module according to a second embodiment of the present invention. The configuration of the liquid crystal display module according to this embodiment is similar to that according to the above-mentioned first embodiment except that the liquid crystal display panel 1 according to this embodiment includes a temperature detector 41.

The configuration of this embodiment will now be described, focusing on the difference between this embodiment and the above-mentioned embodiment. The temperature detector 41 may be provided on a printed wiring board, for example, on that on which the display control circuit 4 is mounted.

In general, the response of the liquid crystal particles is influenced by the temperature. Therefore, the optimal value of the correction voltage indicated by the ΔVa of FIG. 6 varies with the temperature.

In this embodiment, the temperature of the liquid crystal display panel 1 is detected by the temperature detector 41, the first group of the gray-scale reference voltages VR1 to VR12 are changed according to the detected temperature, and the optimal value of the correction voltage indicated by the ΔVa of FIG. 6 is changed according to such changes.

Specifically, a first temperature (e.g., 20 degrees or less) is defined as T1, and a second temperature (e.g., 30 degrees or more) higher than the first temperature is defined as T2 (T1<T2). Also, the values of the first group of the positive and negative 0 to 255-level gray-scale voltages VA to be provided to the image lines DL in the frame A in a case where the temperature detected by the temperature detector 41 is the T1 is defined as VAT1, and the values of the first group of the positive and negative 0 to 255-level gray-scale voltages VA to be provided to the image lines DL in the frame A in a case where the temperature detected by the temperature detector 41 is the T2 is defined as VAT1. Then, the respective values of the VAT1 and VAT2 are set up so that |VAT1|>|VAT2| is satisfied at least in halftones.

That is, the response of the liquid crystal particles becomes faster as the temperature is higher. Therefore, when the temperature is higher, the optimal voltage of the correction voltage indicated by the ΔVa of FIG. 6 is made lower.

For this reason, in this embodiment, if the first group of the gray-scale reference voltages generated and outputted by the gray-scale reference voltage generation circuit 6 when the temperature is T1 in the frame A are defined as VR1T1 to VR12T1, and if the first group of the gray-scale reference voltages generated and outputted by the gray-scale reference voltage generation circuit 6 when the temperature is T2 in the frame A are defined as VR1T2 to VR12T2, the first group of gray-scale reference voltages are set up so that Third Formula below is satisfied.

|VR1T|=|VR1T2|

|VR12T1|=|V12R1T2|

|VRkT1|<|VRkT2|(k=2 to 11) [Third Formula]

Specifically, the first group of gray-scale reference voltages VR1T1 to VR12T1 or VR1T2 to VR12T2 may be selected according to the temperature detected by the temperature circuit 41 and outputted to the gray-scale voltage generation circuit 24-1 of the drain driver 2 by previously storing, in the register 66, data on the respective first group of gray-scale reference voltages corresponding to the temperatures of the liquid crystal display panel 1, and then by changing control data to be outputted from the register 66 according to an instruction from the display control circuit 4, according to the temperature of the liquid crystal display panel 1 detected by the temperature detector 41 so as to change the resistance to be selected by the selector circuit 65. The data on the first group of gray-scale reference voltages VR1T1 to VR12T1 or VR1T2 to VR12T2 is stored in the memory 40 of the display control circuit 4 as data on the gray-scale reference voltages.

Further, if the temperature is high, the correction voltage indicated by the ΔVa of FIG. 6 may be set to the optimal value in two frames: the first frame (frame A) immediately after a phase inversion and a frame (hereafter referred to as a “frame C”) following the first frame.

Specifically, the correction voltage indicated by the ΔVa of FIG. 6 may be set to a voltage value subjected to an over-correction (correction that makes brightness lower than that in normally black characteristic) in the frame A and then may be set to the optimal voltage obtained by subjecting the over-corrected voltage value to a reverse-correction (correction that makes brightness higher than that in normally black characteristic) in the frame C.

Here, if the first group of gray-scale voltages in the frame C are defined as VAF2, |VB|<|VAF2| is satisfied at least in halftones.

For this reason, if gray-scale reference voltages generated by the gray-scale reference voltage generation circuit 6 in the frame C are defined as a third group of gray-scale reference voltages, and if the gray-scale reference voltages forming the third group are defined as VRC1 to VRC12, the VRC1 to VRC12 are set so that Fourth Formula below is satisfied.

|V1|≦|VRC1|

|V12|≦|VRC12|

|Vk|<|VRCk|(k=2 to 11) [Fourth Formula]

Specifically, the first group of gray-scale reference voltages VRC1 to VRC12 are selected and outputted to the gray-scale voltage generation circuit 24-1 of the drain driver 2 by previously storing data on the respective first group of gray-scale reference voltages in the register 66, and then by changing control data to be outputted from the register 66 based on an instruction from the display control circuit 4, according to the temperature of the liquid crystal display panel 1 detected by the temperature detector 41 so as to change the resistance to be selected by the selector circuit 65. The data on the first group of gray-scale reference voltages VRC1 to VRC12 is stored in the memory 40 of the display control circuit 4 as data on the gray-scale reference voltages.

### Third Embodiment

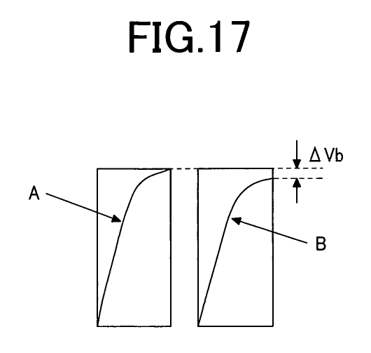

FIG. 17 is a diagram showing the reason why flicker occurs in the first frame immediately after a phase inversion in a case where the phase inversion drive method shown in FIG. 6 is used. In other words, FIG. 17 is a diagram showing an image voltage written to a subpixel in the first frame immediately after a phase inversion in a case where the phase inversion drive method shown in FIG. 6 is used and an image voltage written to a subpixel in a case where the AC drive method shown in FIG. 12 is used.

In the AC drive method shown in FIG. 12, the voltage of a subpixel changes from a positive image voltage to a negative image voltage or from a negative image voltage to a positive image voltage each time the current alternates. On the other hand, if a subpixel has continuous identical polarities such as (−) (−)→(−) (−) or (+) (+)→(+) (+) by using the phase inversion drive method shown in FIG. 6, the voltage of the subpixel changes from a positive image voltage to another positive image voltage or from a negative image voltage to another negative image voltage in the first frame immediately after a phase inversion.

For this reason, an image voltage (A in FIG. 17) written to the subpixel in the first frame immediately after a phase inversion in a case where the phase inversion drive method shown in FIG. 6 is used becomes higher by a voltage ΔVb than an image voltage (B in FIG. 17) written to the subpixel in a case where the AC drive method in FIG. 12 is used. As a result, the above-mentioned flicker occurs in the first frame immediately after a phase inversion in a case where the phase inversion drive method shown in FIG. 6 is used.

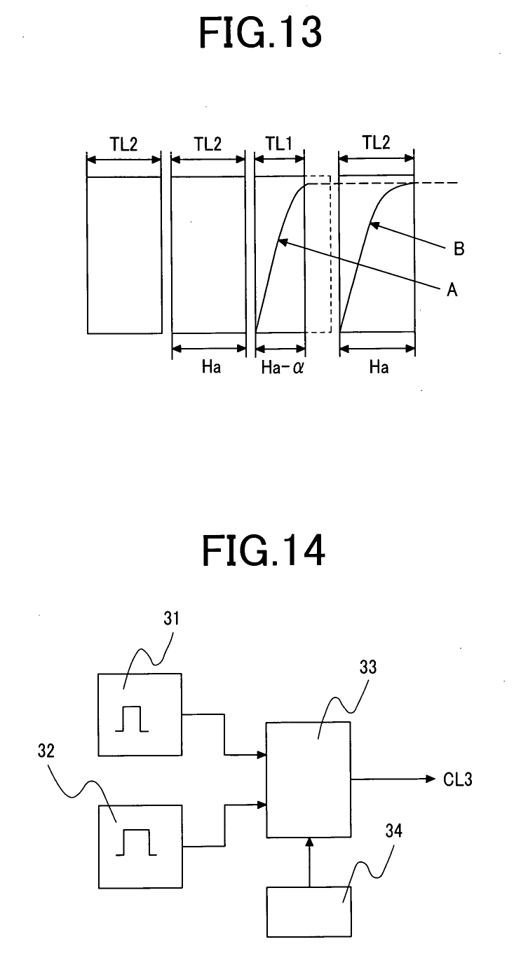

To address this problem, in this embodiment, the length of one horizontal scan period TL1 in the frame A that is the first frame immediately after a phase inversion is made shorter than that of one horizontal scan period TL2 in the frame B that is a normal frame, as shown in FIG. 13. Specifically, in this embodiment, the length of one horizontal scan period TL1 in the frame A is set to (Ha−α), while the length of one horizontal scan period TL2 in the frame B is set to the Ha, which is the normal length of one horizontal scan period. Here, the α is a value set for each liquid crystal module.

According to this embodiment, the time for writing an image voltage to a subpixel in one horizontal scan period in the first frame A is made shorter than the time for writing an image voltage to a subpixel in one horizontal scan period in the frame B. Therefore, the difference between an image voltage (A in FIG. 13) to be written to a subpixel in one horizontal scan period in the first frame A and an image voltage (B in FIG. 13) to be written to a subpixel in the frame B is made approximately 0V. This prevents occurrence of the above-mentioned flicker in the first frame immediately after a phase inversion.

FIG. 13 is a diagram showing an image voltage written to a subpixel in the first frame immediately after a phase inversion and an image voltage written to the subpixel in a normal frame in a liquid crystal display module according to this embodiment.

FIG. 14 is a block diagram showing a configuration of circuits for performing the timing control shown in FIG. 13. These circuits are provided in the display control circuit 4.

In FIG. 14, a clock generation circuit 31 generates a clock having a high-level, short pulse width. Specifically, it generates a shift clock CL3 to be provided to the gate driver 3 in the frame B, which is a normal frame. A clock generation circuit 32 generates a clock having a high-level, long pulse width. Specifically, it generates a shift clock CL3 to be provided to the gate driver 3 in the frame A, which is the first frame immediately after a phase inversion.

As the high-level pulse width of the shift clock CL3 becomes longer, the point of time when a thin film transistor TFT is gated off is moved up, whereby the length of one horizontal scan period is shortened. As a result, the time for writing an image voltage to a subpixel is shortened.

Clocks outputted from the clock generation circuits 31 and 32 are selected by the selector 33 and then provided to the gate driver 3. The selector 33 is controlled by the control circuit 34. The control circuit 34 controls the selector 33 according to whether the frame is the frame A or the frame B.

While a case has been described in which the difference between an image voltage to be written to a subpixel in the frame A that is the first frame immediately after a phase inversion and an image voltage to be written to a subpixel in the frame B that is a normal frame is made approximately 0V by changing the length of one horizontal scan period of the frame A, such a voltage difference is also made approximately 0V by delaying the timing at which an image voltage is outputted from the drain driver 2 in one horizontal scan period in the frame A.

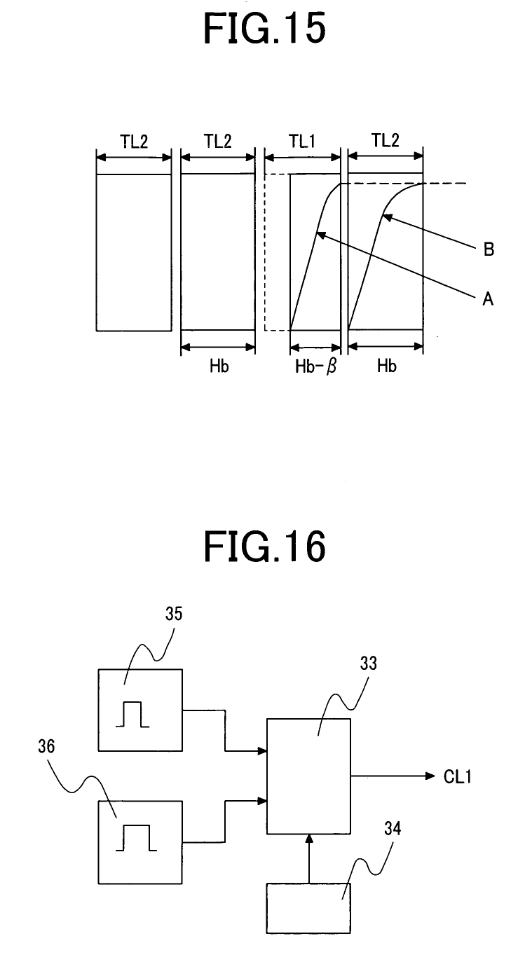

Specifically, as shown in FIG. 15, the image voltage reference write time in one horizontal scan period is defined as Hb, and an arbitrary value is defined as β. Then, the image voltage write time in one horizontal scan period TF1 in the frame A is set to Hb−β and the image voltage write time in one horizontal scan period TF2 in the frame B is set to Hb.

Also in this modification, the time for writing an image voltage to a subpixel in one horizontal scan period in the frame A is made smaller than the time for writing an image voltage to a subpixel in one horizontal scan period in the frame B. As a result, the difference between an image voltage (A in FIG. 15) to be written to a subpixel in the frame A and an image voltage (B in FIG. 15) to be written to a subpixel in the frame B is made approximately 0V. This prevents occurrence of the above-mentioned flicker in the frame A.

FIG. 15 is a diagram showing an image voltage to be written to a subpixel in the first frame immediately after a phase inversion and an image voltage to be written to a subpixel in a normal frame in a liquid crystal display module according to a modification of this embodiment.

FIG. 16 is a block diagram showing a configuration of circuits for performing the timing control shown in FIG. 15. These circuits are provided in the display control circuit 4.

In FIG. 16, a clock generation circuit 35 generates a clock having a high-level, short pulse width. Specifically, it generates an output timing control clock CL1 to be provided to the drain driver 2 in one horizontal period TL2 in the frame B that is a normal frame. A clock generation circuit 36 generates a clock having a high-level, long pulse width. Specifically, it generates an output timing control clock CL1 to be provided to the drain driver 2 in one horizontal period TL1 in the frame A that is the first frame immediately after a phase inversion.

If the high-level pulse width of the output timing control clock CL1 becomes longer, the timing when an image voltage is outputted from the drain driver 2 to each image line DL is delayed, whereby the time for writing an image voltage to a subpixel in one horizontal scan period is shortened.

Clocks outputted from the clock generation circuits 35 and 36 are selected by the selector 33 and then provided to the drain driver 2. The selector 33 is controlled by the control circuit 34. The control circuit 34 controls the selector 33 according to whether the frame is the frame A or the frame B.

While a case where the present invention is applied to the phase inversion drive method in which the drive state of a subpixel is changed from a positive drive state to a negative drive state or from a negative drive state to a positive drive state every two frames and the phase of the drive state of the subpixel is inverted every N frames (N≧4) has heretofore been described, the invention is also applicable to a phase inversion drive method in which the drive state of a subpixel is changed from a positive drive state to a negative drive state or from a negative drive state to a positive drive state for each frame and the phase of the drive state of the subpixel is inverted every M frames (M≧2).

Incidentally, the embodiments have heretofore been described in which the present invention is applied to an in-plane-switching (IPS) liquid crystal display device; however, without being limited to this, the invention is also applicable to twisted nematic (TN) and vertical alignment (VA) liquid crystal display devices. Note that with regard to TN and VA liquid crystal display devices, the counter electrode CT is provided on the second substrate.

The present invention has been described in detail on the basis of the embodiments, the invention is not limited thereto and various changes and modifications can be made to these embodiments without departing from the spirit and scope of the invention.

What is claimed is:

1. A liquid crystal display device comprising:
a liquid crystal display panel including:
a plurality of subpixels each having:
a pixel electrode; and
a counter electrode;
a plurality of image lines that input gray-scale voltages to the subpixels; and
an image line drive circuit that provides the gray-scale voltages to the image lines,
wherein if a drive state of each of the subpixels at a time when a gray-scale voltage higher than a counter voltage applied to the counter electrode is applied to the pixel electrode is defined as a positive drive state and if the drive state of each subpixel at a time when a gray-scale voltage lower than a counter voltage applied to the counter electrode is applied to the pixel electrode is defined as a negative drive state, the image line drive circuit changes the drive state of each subpixel from the positive drive state to the negative drive state or from the negative drive state to the positive drive state every two frames, as well as inverts a phase of the drive state of each subpixel every N (N≧4) frames, and
if a gray-scale voltage to be provided to each of the image lines by the image line drive circuit in a frame A that is a first frame immediately after the phase inversion is defined as VA, and if a normal gray-scale voltage to be provided to each of the image lines by the image line drive circuit in a frame B that is a normal frame is defined as VB, |VA|<|VB| is satisfied at least with respect to a halftone.

2. The liquid crystal display device according to claim 1, further comprising:
a gray-scale reference voltage generation circuit that generates a plurality of gray-scale reference voltages,
wherein the image line drive circuit includes a gray-scale voltage generation circuit that generates the gray-scale voltages based on a plurality of gray-scale reference voltages inputted from the gray-scale reference voltage generation circuit, and
if the gray-scale reference voltages generated by the gray-scale reference voltage generation circuit in the frame A are defined as a first group of gray-scale reference voltages, if the gray-scale reference voltages forming the first group are defined as VR1 to VRj (j≧3), if the gray-scale reference voltages generated by the gray-scale reference voltage generation circuit in the frame B are defined as a second group of gray-scale reference voltages, and if the gray-scale reference voltages forming the second group are defined as V1 to Vj, |VRk|<|Vk|(k=2 to (j−1)) is satisfied.

3. The liquid crystal display device according to claim 2,
wherein the display panel includes a plurality of scan lines that input selection scan voltages to the subpixels,
the gray-scale reference voltage generation circuit changes the gray-scale reference voltage VRk (k=2 to (j−1)) according to positions of the scan lines to which the selection scan voltages are to be provided, and
the image line drive circuit changes a value of the |VA| at least with respect to a halftone according to distances from the image line drive circuit to the scan lines when the gray-scale voltages are written to the subpixels on the scan lines to which the selection scan voltages are to be provided.

4. The liquid crystal display device according to claim 3,
wherein if the VA in a case in which the scan lines to which the selection scan voltages are to be provided are located in a position near the image line drive circuit is defined as VAn, if the VA in a case in which the scan lines to which the selection scan voltages are to be provided are located in a position far from the image line drive circuit is defined as VAf, and if the VA in a case in which the scan lines to which the selection scan voltages are to be provided are located in a middle position between the position near the image line drive circuit and the position far from the image line drive circuit is defined as VAm, |VAn|<|VAm|<|VAf| is satisfied at least with respect to a halftone.

5. The liquid crystal display device according to claim 2, further comprising:
a display control circuit,
wherein the gray-scale reference voltage generation circuit sets up values of the gray-scale reference voltages to be generated in each frame based on gray-scale reference voltage data from the display control circuit.

6. The liquid crystal display device according to claim 5,
wherein the display control circuit includes a memory that stores the gray-scale reference voltage data, and
the display control circuit reads the gray-scale reference voltage data stored in the memory and transmits the read gray-scale reference voltage data to the gray-scale reference voltage generation circuit.

7. The liquid crystal display device according to claim 6,
wherein the memory is an electronically erasable and programmable read-only memory (EEPROM).

8. The liquid crystal display device according to claim 1,
wherein the counter voltage applied to the counter electrode is a constant voltage.

9. The liquid crystal display device according to claim 1,
wherein the liquid crystal display panel includes a pair of substrates between which liquid crystal is interposed,
the pixel electrode and the counter electrode are formed on one of the pair of substrates, and
the pixel electrode and the counter electrode are stacked with an insulating film therebetween.

10. A liquid crystal display device comprising:
a liquid crystal display panel including:
a plurality of subpixels each having:
a pixel electrode; and
a counter electrode;
a plurality of image lines that input gray-scale voltages to the subpixels; and
a printed wiring board on which a display control circuit for performing a timing adjustment is mounted;
a temperature detector that detects a temperature of the liquid crystal display panel or the printed wiring board; and
an image line drive circuit that provides the gray-scale voltages to the image lines,
wherein if a drive state of each of the subpixels at a time when a gray-scale voltage higher than a counter voltage applied to the counter electrode is applied to the pixel electrode is defined as a positive drive state and if the drive state of each subpixel at a time when a gray-scale voltage lower than a counter voltage applied to the counter electrode is applied to the pixel electrode is defined as a negative drive state, the image line drive circuit changes the drive state of each subpixel from the positive drive state to the negative drive state or from the negative drive state to the positive drive state every two frames, as well as inverts a phase of the drive state of each subpixel every N (N≧4) frames,
if a gray-scale voltage to be provided to each of the image lines by the image line drive circuit in a frame A that is a first frame immediately after the phase inversion is defined as VA, and if a normal gray-scale voltage to be provided to each of the image lines by the image line drive circuit in a frame B that is a normal frame is defined as VB, |VA|<|VB| is satisfied at least with respect to a halftone, and
the VA is set up based on a temperature detected by the temperature detector.

11. The liquid crystal display device according to claim 10,
wherein if a first temperature is defined as T1, if a second temperature higher than the first temperature is defined as T2, if a value of the VA at a time when a temperature detected by the temperature detector is the T1 is defined as VAT1, and if a value of the VA at a time when a temperature detected by the temperature detector is the T2 is defined as VAT2, |VAT1|>|VAT2| is satisfied at least with respect to a halftone.

12. The liquid crystal display device according to claim 11,
a gray-scale reference voltage generation circuit that generates a plurality of gray-scale reference voltages,
wherein if the first group of gray-scale reference voltages generated by the gray-scale reference voltage generation circuit when a temperature detected by the temperature detector is the T1 are defined as VRT1 to VRjT1 (j≧3), and if the first group of gray-scale reference voltages generated by the gray-scale reference voltage generation circuit when a temperature detected by the temperature detector is the T2 are defined as VR1T2 to VTjT2, |VRkT1|>|VRkT2|(k=2 to (j−1)) is satisfied.

13. The liquid crystal display device according to claim 11,
wherein if a gray-scale voltage provided to each of the image lines by the image line drive circuit in a frame C that is a frame following the frame A that is the first frame immediately after the phase inversion when a temperature detected by the temperature detector is the T2 is defined as VA2, |VB|<|VA2| is satisfied at least with respect to a halftone.

14. The liquid crystal display device according to claim 13,
a gray-scale reference voltage generation circuit that generates a plurality of gray-scale reference voltages,
wherein if the first group of gray-scale reference voltages generated by the gray-scale reference voltage generation circuit in the frame C are defined as VRC1 to VRCj (j≧3), |Vk|<|VRCk|(k=2 to (j−1)) is satisfied.

15. The liquid crystal display device according to claim 12, further comprising:
a display control circuit,
wherein the gray-scale reference voltage generation circuit sets up values of the gray-scale reference voltages to be generated in each frame based on gray-scale reference voltage data from the display control circuit.

16. A liquid crystal display device comprising:
a liquid crystal display panel including:
a plurality of subpixels each having:
a pixel electrode; and
a counter electrode;
a plurality of scan lines that input scan voltages to the subpixels; and
a plurality of image lines that input image voltages to the subpixels; and
a scan line drive circuit that provides the scan voltages to the scan lines; and
an image line drive circuit that provides the image voltages to the image lines,
wherein if a drive state of each of the subpixels at a time when a gray-scale voltage higher than a counter voltage applied to the counter electrode is applied to the pixel electrode is defined as a positive drive state and if the drive state of each subpixel at a time when a gray-scale voltage lower than a counter voltage applied to the counter electrode is applied to the pixel electrode is defined as a negative drive state, the image line drive circuit changes the drive state of each subpixel from the positive drive state to the negative drive state or from the negative drive state to the positive drive state every two frames, as well as inverts a phase of the drive state of each subpixel every N (N≧4) frames, and
if a length of one horizontal scan period is defined as Ha and if an arbitrary value is defined as α, a length of one horizontal scan period in a frame A that is a first frame immediately after the phase inversion is set to (Ha−α) and a length of one horizontal scan period in a frame B that is a normal frame is set to the Ha.

17. The liquid crystal display device according to claim 16, further comprising:
a display control circuit that transmits a shift clock to the scan line drive circuit,
wherein the display control circuit changes a pulse width of the shift clock so that a length of one horizontal scan period in the frame A becomes (Ha−α) and so that a length of one horizontal scan period in the frame B becomes the Ha.

18. The liquid crystal display device according to claim 17,
wherein a high-level pulse width of the shift clock in one horizontal scan period in the frame A is wider than a high-level pulse width of the shift clock in one horizontal scan period in the frame B.

19. The liquid crystal display device according to claim 16,
wherein the counter voltage applied to the counter electrode is a constant voltage.

20. A liquid crystal display device comprising:
a liquid crystal display panel including:
a plurality of subpixels each having:
a pixel electrode; and
a counter electrode;
a plurality of scan lines that input scan voltages to the subpixels; and
a plurality of image lines that input image voltages to the subpixels; and
a scan line drive circuit that provides the scan voltages to the scan lines; and
an image line drive circuit that provides the image voltages to the image lines,
wherein if a drive state of each of the subpixels at a time when a gray-scale voltage higher than a counter voltage applied to the counter electrode is applied to the pixel electrode is defined as a positive drive state and if the drive state of each subpixel at a time when a gray-scale voltage lower than a counter voltage applied to the counter electrode is applied to the pixel electrode is defined as a negative drive state, the image line drive circuit changes the drive state of each subpixel from the positive drive state to the negative drive state or from the negative drive state to the positive drive state every two frames, as well as inverts a phase of the drive state of each subpixel every N (N≧4) frames, and
if an image voltage reference write time in one horizontal scan period is defined as Hb and if an arbitrary value is defined as β, an image voltage reference write time in one horizontal scan period in a frame A that is a first frame immediately after the phase inversion is set to (Ha−β) and an image voltage reference write time in one horizontal scan period in a frame B that is a normal frame is set to the Hb.

21. The liquid crystal display device according to claim 20, further comprising:
a display control circuit that transmits an output timing control clock to the image line drive circuit,
wherein the display control circuit changes a pulse width of the output timing control clock so that an image voltage reference write time in one horizontal scan period in the frame A is set to (Ha−β) and an image voltage reference write time in one horizontal scan period in the frame B is set to the Hb.

22. The liquid crystal display device according to claim 21,
wherein a high-level pulse width of the output timing control clock in one horizontal scan period in the frame A is wider than a high-level pulse width of the output timing control clock in one horizontal scan period in the frame B.

23. A liquid crystal display device comprising:
a liquid crystal display panel including:
a plurality of subpixels each having:
a pixel electrode; and
a counter electrode;
a plurality of image lines that input gray-scale voltages to the subpixels; and
an image line drive circuit that provides the gray-scale voltages to the image lines,
wherein if a drive state of each of the subpixels at a time when a gray-scale voltage higher than a counter voltage applied to the counter electrode is applied to the pixel electrode is defined as a positive drive state and if the drive state of each subpixel at a time when a gray-scale voltage lower than a counter voltage applied to the counter electrode is applied to the pixel electrode is defined as a negative drive state, the image line drive circuit changes the drive state of each subpixel from the positive drive state to the negative drive state or from the negative drive state to the positive drive state for each frame, as well as inverts a phase of the drive state of each subpixel every M (M≧2) frames,
if a gray-scale voltage to be provided to each of the image lines by the image line drive circuit in a frame A that is a first frame immediately after the phase inversion is defined as VA, and if a normal gray-scale voltage to be provided to each of the image lines by the image line drive circuit in a frame B that is a normal frame is defined as VB, |VA|<|VB| is satisfied at least with respect to a halftone.

24. A liquid crystal display device comprising:
a liquid crystal display panel including:
a plurality of subpixels each having:
a pixel electrode; and
a counter electrode;
a plurality of scan lines that input scan voltages to the subpixels;
a plurality of image lines that input image voltages to the subpixels; and
a scan line drive circuit that provides the scan voltages to the scan lines; and
an image line drive circuit that provides the image voltages to the image lines,
wherein if a drive state of each of the subpixels at a time when a gray-scale voltage higher than a counter voltage applied to the counter electrode is applied to the pixel electrode is defined as a positive drive state and if the drive state of each subpixel at a time when a gray-scale voltage lower than a counter voltage applied to the counter electrode is applied to the pixel electrode is defined as a negative drive state, the image line drive circuit changes the drive state of each subpixel from the positive drive state to the negative drive state or from the negative drive state to the positive drive state for each frame, as well as inverts a phase of the drive state of each subpixel every M (M≧2) frames, and
if a length of one horizontal scan period is defined as Ha and if an arbitrary value is defined as α, a length of one horizontal scan period in a frame A that is a first frame immediately after the phase inversion is set to (Ha−α) and a length of one horizontal scan period in a frame B that is a normal frame is set to the Ha.

25. A liquid crystal display device comprising:
a liquid crystal display panel including:
a plurality of subpixels each having:
a pixel electrode; and
a counter electrode;
a plurality of scan lines that input scan voltages to the subpixels;
a plurality of image lines that input image voltages to the subpixels; and
a scan line drive circuit that provides the scan voltages to the scan lines; and
an image line drive circuit that provides the image voltages to the image lines,
wherein if a drive state of each of the subpixels at a time when a gray-scale voltage higher than a counter voltage applied to the counter electrode is applied to the pixel electrode is defined as a positive drive state and if the drive state of each subpixel at a time when a gray-scale voltage lower than a counter voltage applied to the counter electrode is applied to the pixel electrode is defined as a negative drive state, the image line drive circuit changes the drive state of each subpixel from the positive drive state to the negative drive state or from the negative drive state to the positive drive state for each frame, as well as inverts a phase of the drive state of each subpixel every M (M≧2) frames, and
if an image voltage reference write time in one horizontal scan period is defined as Hb and if an arbitrary value is defined as β, an image voltage reference write time in one horizontal scan period in a frame A that is a first frame immediately after the phase inversion is set to (Ha−β) and an image voltage reference write time in one horizontal scan period in a frame B that is a normal frame is set to the Hb.
